(19) United States
(12) Patent Application Publication
(10) Pub. No.: US 2024/0358137 A1
(43) Pub. Date: Oct. 31, 2024

(54) REFILLABLE COLLARED CONTAINER FOR PRODUCT DISPENSING

(71) Applicant: L'Oreal, Paris (FR)

(72) Inventors: Wenzhen CHENG, Annadale, NJ (US); William BICKFORD, Scotch Plains, NJ (US); Luc MAELSTAF, Scotch Plains, NJ (US); Jason FYFE, Scotch Plains, NJ (US)

(73) Assignee: L'Oreal, Paris (FR)

(21) Appl. No.: 18/308,949

(22) Filed: Apr. 28, 2023

(51) Int. Cl. A45D 33/12; A45D 34/04; A45D 40/26; B05B 11/10; B65D 47/42

(52) U.S. Cl. CPC A45D 33/12; A45D 34/041; A45D 34/042; A45D 40/261; A45D 40/262; B05B 11/1047; B65D 47/42; A45D 2200/054; A45D 2200/1009; B65D 2547/04

(57) ABSTRACT

A collar for use with a bottle that is refillable for refilling the bottle with a product, and containers comprised of bottles having the collar attached thereto. The collar is removably attachable to the bottle for removable attachment of an applicator to the bottle. The bottle contains a liquid, powder, or other flowable product that is applied with the applicator to a surface during use of the applicator. To remove the applicator from the bottle, a flexible ring of the collar is depressed with pressure applied at opposite buttons of the collar to deform the flexible ring and slide at least one ring tab of the flexible ring past at least one stop lug of the bottle to allow the collar to rotate with respect to the bottle and be removed from the bottle.

### SUMMARY

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

In an aspect, the disclosure provides a collar for a container. The collar comprises a flexible ring having first and second buttons opposite each other and at least one ring tab for abutment against at least one stop lug of a bottle in a closed configuration of the container, and a collar body having at least one body tab to movably secure the flexible ring with the collar body. Pressure applied at the first and second buttons deforms the flexible ring and slides the at least one ring tab outward past the at least one stop lug of the bottle for transition from the closed configuration to an open configuration of the container.

In another aspect, the disclosure provides a collared container. The collared container comprises a bottle and an applicator removably attached to the bottle by way of a collar. The collar includes a flexible ring having first and second buttons opposite each other and at least one ring tab for abutment against at least one stop lug of the bottle in a closed configuration of the container, and a collar body having at least one body tab to movably secure the flexible ring with the collar body. Pressure applied at the first and second buttons deforms the flexible ring and slides the at least one ring tab outward past the at least one stop lug of the bottle for transition from the closed configuration to an open configuration of the container.

### DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1 shows a perspective view of an example container with a bottle, a collar, and an over cap in a closed position.

FIG. 2 shows a perspective view of the container with the over cap in an open position.

FIG. 3 shows a perspective view of the container in an exploded configuration.

FIG. 4 shows a perspective cutaway view of the container with the over cap in the closed position.

FIG. 5 shows a front perspective cutaway view of the container with the over cap removed.

FIG. 6 shows a perspective view of a lateral cutaway of the container, with the cutaway position at a flexible ring of the collar.

FIG. 7A shows an upper perspective view of the collar.

FIG. 7B shows a lower perspective view of the collar.

FIG. 8 shows a perspective view of the bottle with the collar removed.

FIG. 9A shows an upper plan view of the bottle with elements of the collar in broken lines.

FIG. 9B shows the upper plan view of the bottle with elements of the collar in broken lines, with long black arrows indicating pressure applied to buttons of the collar and short black arrows indicating a direction of deformation of the flexible ring at these positions.

FIG. 10 shows a perspective view of a bottle with a first example applicator attached thereto.

FIG. 11 shows a perspective view of a bottle with a second example applicator attached thereto.

FIG. 12 shows a perspective view of a bottle with a third example applicator attached thereto.

### DETAILED DESCRIPTION

In a general aspect, the disclosure provides a two-piece collar for use with a bottle and a container that is comprised of the collar and the bottle. The collar is attachable to the bottle for attachment of an applicator to the bottle, and is removable from the bottle for removal of the applicator from the bottle for cleaning, refilling, or recycling the bottle. The bottle can contain a flowable (e.g., liquid, powder, and the like) product that is applied with the applicator to a surface during use of the applicator. Non-limiting example uses for the container include storage and delivery of liquid healthcare and skincare products from the bottle to a subject's skin by way of the applicator. The bottle is refillable and can be cleaned and recycled since the applicator is easily removed from the bottle with use of the collar of the disclosure.

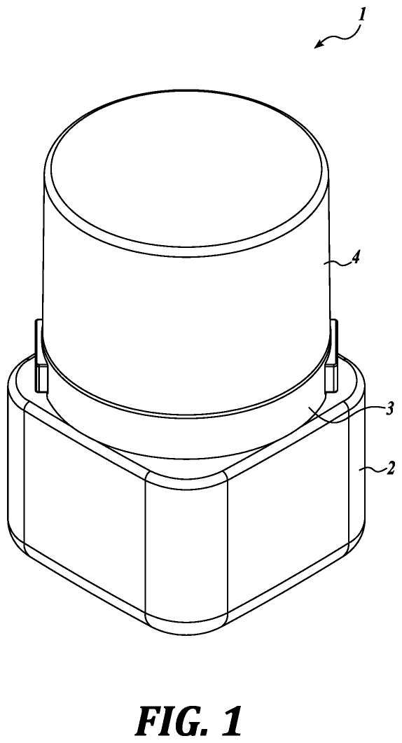

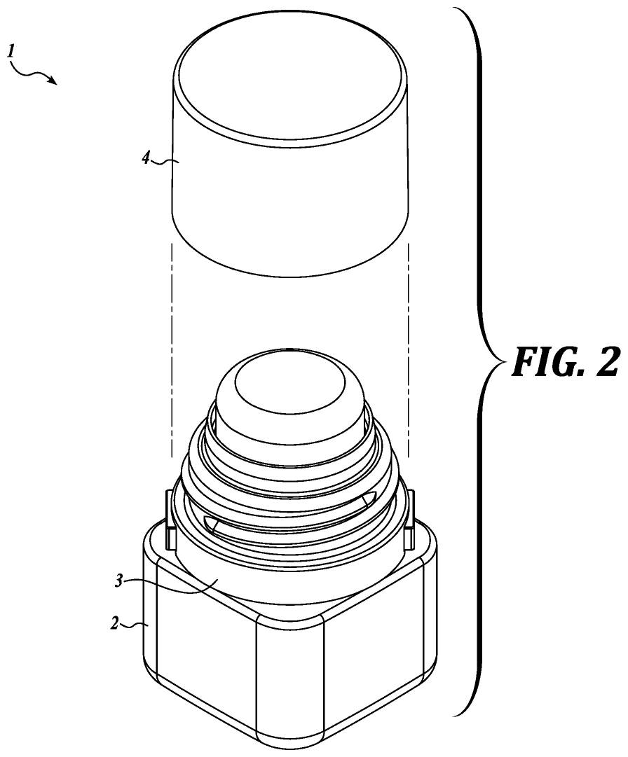

As shown at FIG. 1, container 1 includes a bottle 2, a collar 3, and an over cap 4. A view of container 1 with the over cap 4 removed is shown at FIG. 2. In embodiments, collar 3 is secured to bottle 2 with complementary threading within collar 3 and on outer portions of a lip of bottle 2, and at least one stop lug that keeps the collar in place when container 1 is in use, as described elsewhere herein. In embodiments, over cap 4 is also securable to collar 3 by way of complementary threading within over cap 4 and on outer portions of a lip of the collar, as shown at FIG. 2. In such embodiments, over cap 4 is removable from collar 3 by unscrewing over cap 4 from collar 3 along the complementary threading. In embodiments, over cap 4 is securable to collar 3 by way of a snap-fit or a friction-fit.

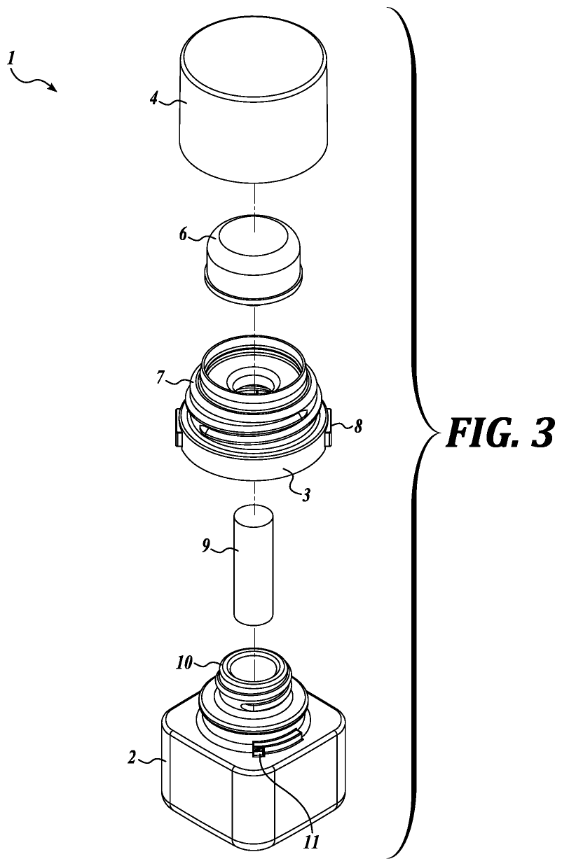

As shown at FIG. 3, the example container 1 can be disassembled such that individual components are separated from each other, for cleaning, maintenance, replacement of parts, recycling, disposal, or refilling of the bottle, for example. Bottle 2 includes at least one stop lug 11 thereon which slidingly engages with portions of collar 3, as explained herein, to secure collar 3 to bottle 2. A lip 10 of bottle 2 is insertable into a lower portion of collar 3 and collar 3 is securable to lip 10 of bottle 2 by complementary threading. When present, an applicator member 9, which can be a straw, a wick, a tube, or a different type of member that is suitable for conveying flowable product from an interior of bottle 2 through collar 3 and to an applicator 6, is insertable into bottle 2 and through collar 3 to securely contact applicator 6. Applicator 6 is securable by a snap fit to an upper portion of collar 3, and an inner cap 5, when present in an embodiment, can be used to cover applicator 6 and be secured to the collar 3 by a snap fit. Over cap 4, when present in an embodiment, can be used to cover applicator 6 and/or inner cap 5, as shown at FIG. 1, to keep the applicator and product fresh. In embodiments, collar 3 includes a flexible ring with a pair of oppositely positioned buttons 8. The flexible ring is movably secured to a collar body 7 of the collar, and the flexible ring and the collar body 7 are structurally distinct components, as explained below.

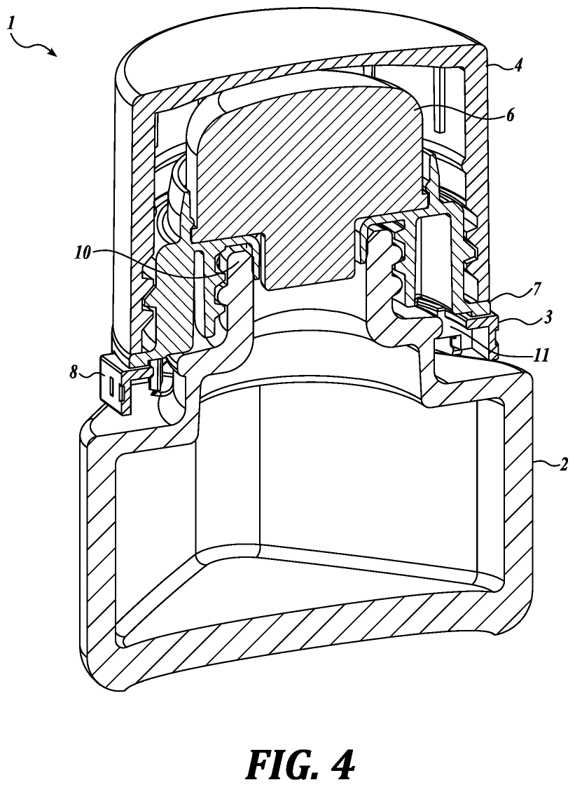

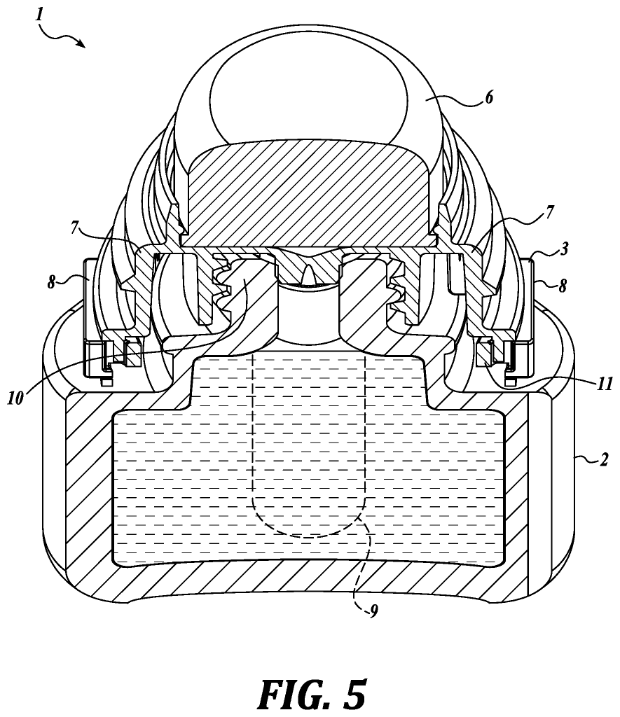

As shown at FIGS. 4 and 5, a seal is formed by applicator 6 and collar 3 to secure a liquid, powder, or other flowable product within the bottle to prevent leakage and maintain the integrity of the product, thereby extending the shelf life of the product. Example container 1 is shown with over cap 4 attached at FIG. 4 and removed at FIG. 5. The seal formed by applicator 6 and collar 3 is intact even when over cap 4 is detached from collar 3, as shown at FIG. 5. In this manner, product within bottle 2 does not leak from bottle 2 or undergo oxidation or evaporation when collar 3 is secured to bottle 2 in a closed configuration of container 1. Inner cap 5, when present in an embodiment (e.g., as shown at FIG. 5), forms a seal around applicator 6, thereby preventing leakage or evaporation of product from applicator 6 when the container is not in use. In embodiments that utilize a porous (e.g., porous or sponge) applicator 6, as shown, keeping inner cap 5 secured over porous applicator 6 when not in use maintains the effectiveness of porous applicator 6 and prevents drying of product thereon or therein. Collar 3 is comprised of collar body 7 and the flexible ring which includes opposite buttons 8, the operation of which is further described below.

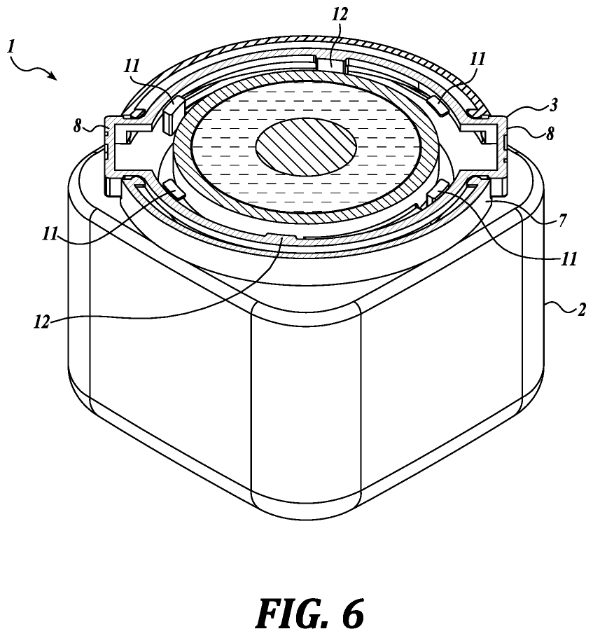

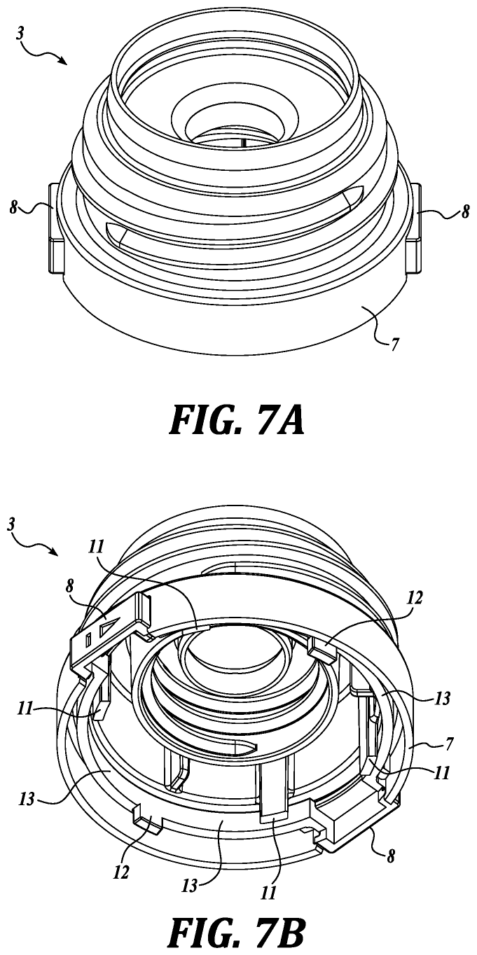

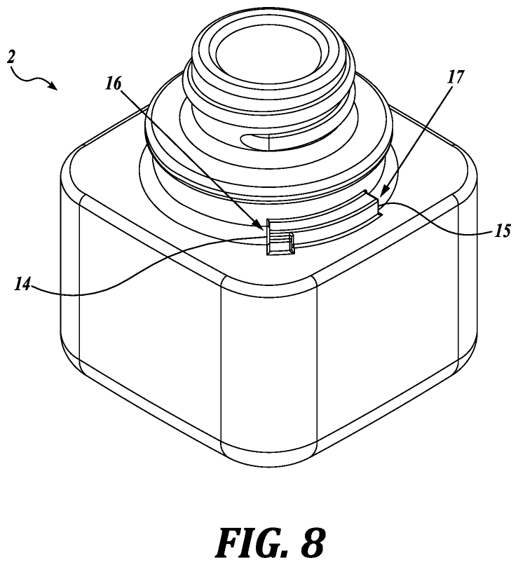

Referring now to FIGS. 6, 7A, 7B, and 8, collar 3 for container 1 comprises flexible ring 13 having first and second buttons 8, positioned opposite each other, and a ring tab 12 for abutment against a stop lug ridge 14 of stop lug of bottle 2 in a closed configuration of container 1. Collar 3 also comprises collar body 7 having a body tab 11 to movably secure flexible ring 13 with collar body 7. As pressure is applied at first and second buttons 8 this deforms flexible ring 13 and slides ring tab 12 outward past stop lug ridge 14 of bottle 2 for transition from the closed configuration of the container 1 to an open configuration of the container 1.

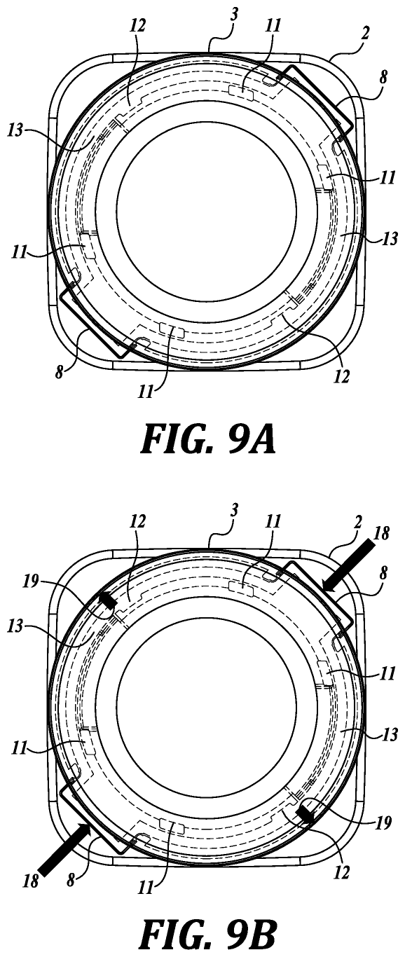

Pressure that can be applied to buttons 8, and directions of the resultant deformation of flexible ring 13, are shown at FIGS. 9A and 9B. Application of pressure at arrows 18 against first and second buttons 8 causes buttons 8 to move toward each other and ring tabs 12 to move away from each other in the direction of arrows 19, as part of a flexible deformation of flexible ring 13. This deformation causes ring tabs 12 to move outward past stop lug ridge 14 of bottle 2, allowing collar 3 to rotate relative to bottle 2 as ring tabs 12 slide from stop lug ridge 14 to stop lug terminus 15. As ring tabs 12 rotate about the neck of bottle 2, threading of collar 3 slides along threading of bottle 2 and collar 3, and any associated applicator, can be removed from bottle 2.

In embodiments, collar 3 includes two components, flexible ring 13 and collar body 7. Flexible ring 13 is movably secured with collar body 7 as a separate, distinct component, and this facilitates the deformation. In the shown embodiment, flexible ring 13 deforms from a circular shape to a non-circular shape as the pressure is applied at the first and second buttons (arrows 18 of FIG. 9B). This results in a shape that at least approximates an ellipse, wherein ring tabs 12 are at vertices of the ellipse, and the first and second buttons 8 are at first and second co-vertexes of the ellipse.

Flexible ring 13 is movably secured with the collar body by way of body tab 11, and is structurally continuous, or connected with, first and second buttons 8. In the shown embodiment, collar 3 includes four body tabs 11 to movably secure flexible ring 13 with the collar body, however, other amounts of body tabs 11 can be used without departing from the scope and spirit of the disclosure. In addition, in the shown embodiment, bottle 2 includes two stop lugs (11 of FIG. 3) and the flexible ring 13 includes two ring tabs (12 of FIGS. 9A and 9B), however, other amounts of stop lugs and ring tabs can be used without departing from the scope and spirit of the disclosure. In addition, in the shown embodiment the two stop lugs are oppositely positioned on bottle 2 and the two ring tabs 12 are oppositely positioned on flexible ring 13, however, alternate positions for these elements can be implemented without departing from the scope and spirit of the disclosure.

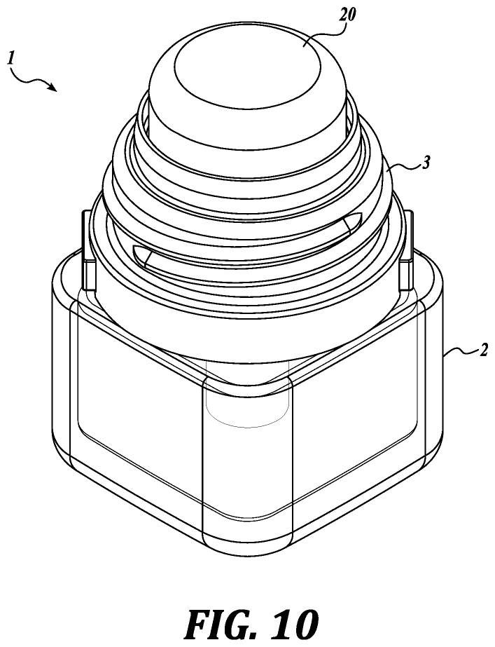

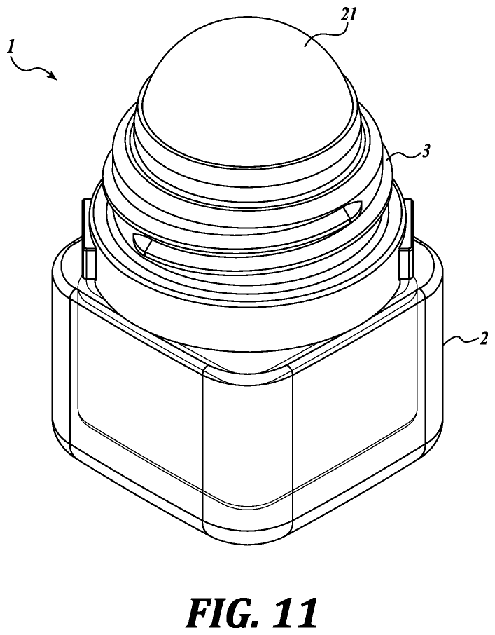

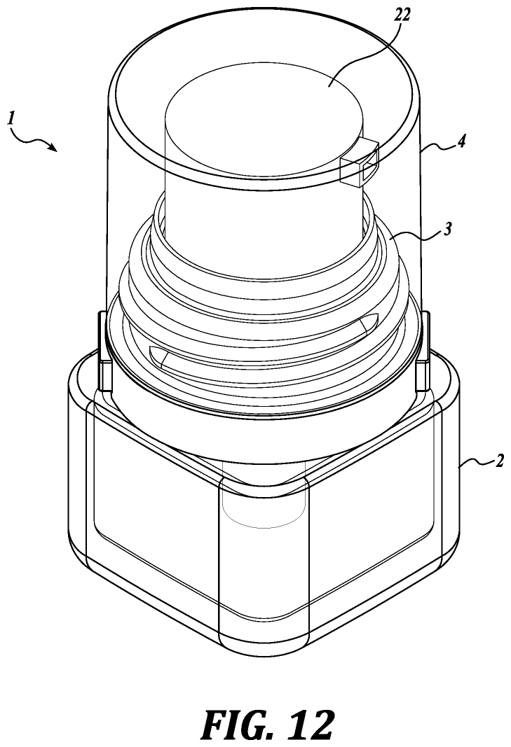

In general, collar 3 can be any shape and can be used with any type, shape, or size of bottle 2 or container 1, of any material including but not limited to glass, metal, alloy, ceramic, polymer, plastic, and the like. It is desirable that the flexible ring 13 of the collar 3 be circular and flexible, and so while a particular embodiment can include a plastic flexible ring 13, other flexible or deformable materials can be used for flexible ring 13, including but not limited to plastic, composite material, shape-memory alloy, or additive-manufacturing material. Collar 3 can be used with any type of applicator configured for application of a liquid or other flowable product to a surface, such as a subject's skin. Example types of applicators that can be used are shown at FIGS. 10-12. FIG. 10 shows an example porous applicator 20, FIG. 11 shows an example roller ball applicator 21, and FIG. 12 shows an example pump applicator 22 with over cap 4 attached. Regardless of applicator type, collar 3 removably secures the applicator to the bottle 2, forming a seal to secure and preserve product inside bottle 2, as shown and described herein.

### Non-Limiting Embodiments

While general features of the disclosure are described and shown and particular features of the disclosure are set forth in the claims, the following non-limiting embodiments relate to features, and combinations of features, that are explicitly envisioned as being part of the disclosure. The following non-limiting Embodiments are modular and can be combined with each other in any number, order, or combination to form a new non-limiting Embodiment, which can itself be further combined with other non-limiting Embodiments.

Embodiment 1. A collar for a container, the collar comprising: a flexible ring having first and second buttons opposite each other and at least one ring tab for abutment against at least one stop lug of a bottle in a closed configuration of the container; and a collar body having at least one body tab to movably secure the flexible ring with the collar body; wherein pressure applied at the first and second buttons deforms the flexible ring and slides the at least one ring tab outward past the at least one stop lug of the bottle for transition from the closed configuration to an open configuration of the container.

Embodiment 2. The collar of any other Embodiment, wherein the collar includes four body tabs to movably secure the flexible ring with the collar body.

Embodiment 3. The collar of any other Embodiment, wherein the bottle includes two stop lugs and the flexible ring includes two ring tabs.

Embodiment 4. The collar of any other Embodiment, wherein the two stop lugs are oppositely positioned on the bottle and the two ring tabs are oppositely positioned on the flexible ring.

Embodiment 5. The collar of any other Embodiment, wherein the flexible ring deforms from at least approximately a circular shape to a non-circular shape as pressure is applied at the first and second buttons and returns to at least approximately the circular shape as pressure is released.

Embodiment 6. The collar of any other Embodiment, wherein the non-circular shape is at least approximately an ellipse, the at least one ring tab is at a vertex of the ellipse, and the first and second buttons are at first and second co-vertexes of the ellipse.

Embodiment 7. The collar of any other Embodiment, wherein the bottle includes two stop lugs and the flexible ring includes two ring tabs, and wherein the two stop lugs are oppositely positioned on the bottle and the two ring tabs are oppositely positioned on the flexible ring.

Embodiment 8. A collared container, comprising: a bottle and an applicator removably attached to the bottle by way of a collar, wherein the collar includes: a flexible ring having first and second buttons opposite each other and at least one ring tab for abutment against at least one stop lug of the bottle in a closed configuration of the container; and a collar body having at least one body tab to movably secure the flexible ring with the collar body; wherein pressure applied at the first and second buttons deforms the flexible ring and slides the at least one ring tab outward past the at least one stop lug of the bottle for transition from the closed configuration to an open configuration of the container.

Embodiment 9. The collared container of any other Embodiment, wherein the collar is removably attached to the bottle for removable attachment of the applicator to the bottle.

Embodiment 10. The collared container of any other Embodiment, wherein the applicator is selected from the group consisting of: a porous applicator, a brush applicator, a pump applicator, a sponge applicator, a roller ball applicator, and any combination thereof.

Embodiment 11. The collared container of any other Embodiment, wherein the bottle includes two stop lugs and the flexible ring includes two ring tabs.

Embodiment 12. The collared container of any other Embodiment, wherein the two stop lugs are oppositely positioned on the bottle and the two ring tabs are oppositely positioned on the flexible ring.

Embodiment 13. The collared container of any other Embodiment, wherein the flexible ring deforms from at least approximately a circular shape to a non-circular shape as pressure is applied at the first and second buttons and returns to at least approximately the circular shape as pressure is released.

Embodiment 14. The collared container of any other Embodiment, wherein the non-circular shape is at least approximately an ellipse, the at least one ring tab is at a vertex of the ellipse, and the first and second buttons are at first and second co-vertexes of the ellipse.

Embodiment 15. The collared container of any other Embodiment, wherein the bottle includes two stop lugs and the flexible ring includes two ring tabs, and wherein the two stop lugs are oppositely positioned on the bottle and the two ring tabs are oppositely positioned on the flexible ring.

While illustrative embodiments have been illustrated and described, it will be appreciated that various changes can be made therein without departing from the spirit and scope of the invention.

The embodiments of the invention in which an exclusive property or privilege is claimed are defined as follows:

1. A collar for a container, the collar comprising:
a flexible ring having first and second buttons opposite each other and at least one ring tab for abutment against at least one stop lug ridge of a bottle in a closed configuration of the container; and
a collar body having at least one body tab to movably secure the flexible ring with the collar body;
wherein pressure applied at the first and second buttons deforms the flexible ring and slides the at least one ring tab outward past the at least one stop lug ridge of the container for transition from the closed configuration to an open configuration of the container.

2. The collar of claim 1, wherein the collar includes four body tabs to movably secure the flexible ring with the collar body.

3. The collar of claim 1, wherein the bottle includes two stop lugs and the flexible ring includes two ring tabs.

4. The collar of claim 3, wherein the two stop lugs are oppositely positioned on the bottle and the two ring tabs are oppositely positioned on the flexible ring.

5. The collar of claim 1, wherein the flexible ring deforms from at least approximately a circular shape to a non-circular shape as pressure is applied at the first and second buttons and returns to at least approximately the circular shape as pressure is released.

6. The collar of claim 5, wherein the non-circular shape is at least approximately an ellipse, the at least one ring tab is at a vertex of the ellipse, and the first and second buttons are at first and second co-vertexes of the ellipse.

7. The collar of claim 6, wherein the bottle includes two stop lugs and the flexible ring includes two ring tabs, and wherein the two stop lugs are oppositely positioned on the bottle and the two ring tabs are oppositely positioned on the flexible ring.

8. A collared container, comprising:
a bottle and an applicator removably attached to the bottle by way of a collar, wherein the collar includes:
a flexible ring having first and second buttons opposite each other and at least one ring tab for abutment against at least one stop lug of the bottle in a closed configuration of the container; and
a collar body having at least one body tab to movably secure the flexible ring with the collar body;
wherein pressure applied at the first and second buttons deforms the flexible ring and slides the at least one ring tab outward past the at least one stop lug of the bottle for transition from the closed configuration to an open configuration of the container.

9. The collared container of claim 8, wherein the collar is removably attached to the bottle for removable attachment of the applicator to the bottle.

10. The collared container of claim 8, wherein the applicator is selected from the group consisting of: a porous applicator, a brush applicator, a pump applicator, a sponge applicator, a roller ball applicator, and any combination thereof.

11. The collared container of claim 8, wherein the bottle includes two stop lugs and the flexible ring includes two ring tabs.

12. The collared container of claim 11, wherein the two stop lugs are oppositely positioned on the bottle and the two ring tabs are oppositely positioned on the flexible ring.

13. The collared container of claim 8, wherein the flexible ring deforms from at least approximately a circular shape to a non-circular shape as pressure is applied at the first and second buttons and returns to at least approximately the circular shape as pressure is released.

14. The collared container of claim 13, wherein the non-circular shape is at least approximately an ellipse, the at least one ring tab is at a vertex of the ellipse, and the first and second buttons are at first and second co-vertexes of the ellipse.

15. The collared container of claim 14, wherein the bottle includes two stop lugs and the flexible ring includes two ring tabs, and wherein the two stop lugs are oppositely positioned on the bottle and the two ring tabs are oppositely positioned on the flexible ring.
